(19) United States
(12) Patent Application Publication
(10) Pub. No.: US 2009/0172558 A1
(43) Pub. Date: Jul. 2, 2009

(54) SYSTEM AND METHOD FOR PERSONALIZED CHANGE TRACKING FOR COLLABORATIVE AUTHORING ENVIRONMENTS

(75) Inventors: Jeremy PICKENS, Milpitas, CA (US); Laurent DENOUE, Palo Alto, CA (US)

Correspondence Address: SUGHRUE MION, PLLC, 2100 Pennsylvania Avenue, N.W., Washington, DC, 20037, US

(73) Assignee: FUJI XEROX CO., LTD., Tokyo (JP)

(21) Appl. No.: 11/965,666

(22) Filed: Dec. 27, 2007

(51) Int. Cl. G06F 3/048

(52) U.S. Cl. 715/741; 715/751

(57) ABSTRACT

Personalized change-tracking functionality for collaboratively authored documents is provided. Initially, every document or page for a given user is marked as “new”, “unread” or “unaccessed”. Any time a user edits or even reads a portion of a document, that fact is captured and those segments of the document are marked, for only that user, as “read”. However, any time another user edits that same document, if those edits overwrite areas that the first user has read or edited, or open up new areas, all those areas revert to the “new” or “unread” status. Thus, the next time the user visits that document or page, the display module will show him not what is new, but what is new to him.

### FIELD OF THE INVENTION

The present invention generally relates to document authoring and, more specifically, to tracking changes in collaborative document authoring environments.

### DESCRIPTION OF THE RELATED ART

In the online world, there is an increasing move toward collaborative document authoring environments in which more than a single author contributes whole sections, paragraphs, sentences, or even minute word changes to a jointly-authored document. Pursuant to the aforesaid trend, various document authoring environments have been developed. One exemplary embodiment of such authoring environments is a Wiki environment, well known to persons of skill in the art. However, the aforesaid Wiki document authoring environment, as well as other similar document authoring environments, suffer from a major drawback, wherein it is difficult for a user to keep track of what portions of the document the user has or has not read.

While an entire new section inserted by another user into the document is easy to spot, a few critical wording changes to a sentence are not as easy to notice. On the other hand, as would be appreciated by those of skill in the art, it may be much more important to notice such critical, albeit difficulty noticeable wording changes. The existing change-tracking systems such as those found within Microsoft Word documents, only keep track of changes to the document as a whole. Every change is always displayed to every user.

Thus, the conventional technology fails to provide a personalized change-tracking functionality for collaboratively authored documents.

### SUMMARY OF THE INVENTION

The inventive methodology is directed to methods and systems that substantially obviate one or more of the above and other problems associated with conventional techniques for collaborative document authoring.

In accordance with one aspect of the inventive concept, there is provided a method involving: marking a document as unaccessed; providing the document to a user; detecting a portion of the document accessed by the user; marking the accessed portion of the document as read and determining whether the read portion of the document has been modified by another user. If the read portion of the document has been modified by another user, the read portion of the document is reverted to the unaccessed state.

In accordance with another aspect of the inventive concept, there is provided a computer readable medium embodying a set of computer-executable instructions implementing a method involving marking a document as unaccessed; providing the document to a user; detecting a portion of the document accessed by the user; marking the accessed portion of the document as read and determining whether the read portion of the document has been modified by another user. If the read portion of the document has been modified by another user, the read portion of the document is reverted to the unaccessed state.

In accordance with yet another aspect of the inventive concept, there is provided a change tracking system including a front end portion configured to: authenticate a user to determine an identity of the user; detect changes to a document made by the user; send the detected changes to a back end portion together with information on the identity of the user; collect information on a portion of the document accessed by the user; send information on a portion of the document accessed by the user to the back end portion together with the information on the identity of the user; receive a personalized document data from the back-end portion and display the received data to the user.

In accordance with yet another aspect of the inventive concept, there is provided a change tracking system including a front end portion configured to provide a document to a user; and detect a portion of the document accessed by the user. The inventive system further includes a back end portion configured to store the document; initially mark the document as unaccessed; mark the accessed portion of the document as read and determine whether the read portion of the document has been modified by another user. If the read portion of the document has been modified by another user, the read portion of the document is reverted to the unaccessed state.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a computerized personalized change-tracking system for collaboratively authored documents.

FIG. 2 illustrates an exemplary embodiment of an operating sequence of the inventive computerized personalized change-tracking system for collaboratively authored documents.

FIG. 3 illustrates an exemplary embodiment of an operating sequence of a front-end portion of the inventive computerized personalized change-tracking system for collaboratively authored documents.

FIG. 4 illustrates an exemplary embodiment of an operating sequence of a back-end portion of the inventive computerized personalized change-tracking system for collaboratively authored documents.

FIG. 5 illustrates an exemplary embodiment of a user interface portion of the inventive computerized personalized change-tracking system for collaboratively authored documents.

FIG. 6 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

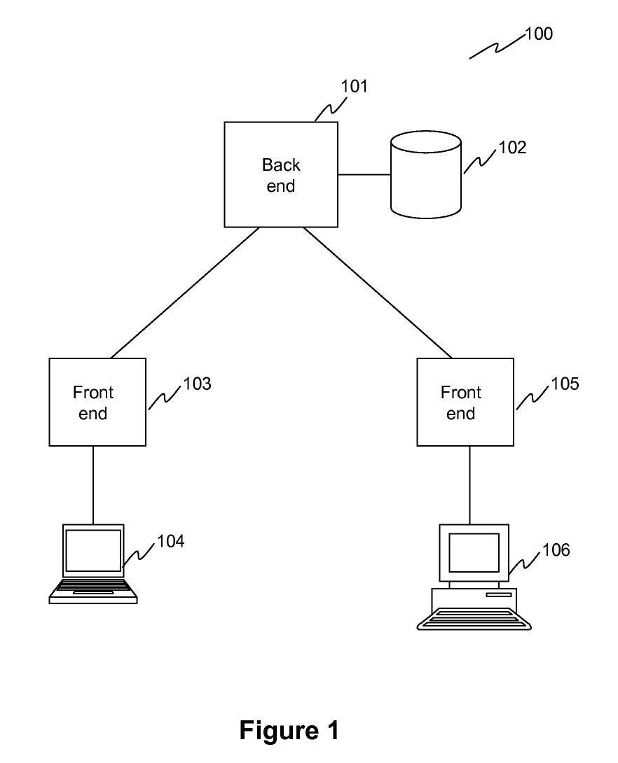

FIG. 1 illustrates an exemplary embodiment 100 of a computerized personalized change-tracking system for collaboratively authored documents. The system 100 shown in that figure includes a back end portion 101, having a storage portion 102 for storing the documents and the related data. The back end portion provides document hosting, serving, and centralized change tracking. Connected to the back end portion 101 are two front end portions 103 and 105. The front-end portions 103 and 105 are associated with display modules 104 and 106, respectively. The display modules 104 and 106 are operable to display personalized change tracking information to the respective users. The front end portions facilitate the document reading by the user and provide document editing capability.

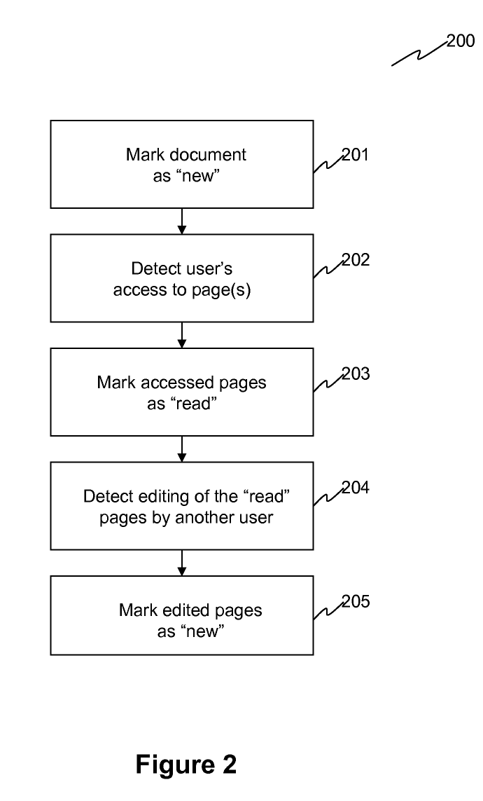

FIG. 2 illustrates an exemplary embodiment of an operating sequence 200 of the inventive computerized personalized change-tracking system for collaboratively authored documents. In accordance with an embodiment of the inventive concept, initially, every document, page or portion thereof for a given user is marked as “new” or “unread,” see step 201. At step 202, an embodiment of the inventive system detects user's access to pages or other portions of the document. Specifically, any time a user edits or even reads a page or other portion of a document, that fact is captured by the inventive system in step 202. At step 203, the accessed pages, portions or segments of the document are marked, for only that user, as “read”. However, any time another user edits that same document (step 204), if those edits overwrite areas that the first user has read or edited, or open up new areas, all those areas revert to the “new” or “unread” status, see step 205. Thus, the next time the user visits that document or page, the display modules 104 or 106 of the inventive system will show him not what is new, but what is new to him.

To better understand the illustrated embodiment of the inventive concept, one may consider an analogy to snow. Every time a user reads or edits a portion of a document, it is like making tracks in the snow. With enough tread, the pristine white snow grays out. Other users are like clouds, raining fresh snow back onto document portions that the first user has already trampled. It should be noted that if there is a document portion that the user has not yet read, and someone else makes an update to that portion, it has no effect on the user. Whether or not there was a change to that previously unseen portion, it will be fresh snow by the time the user visits it.

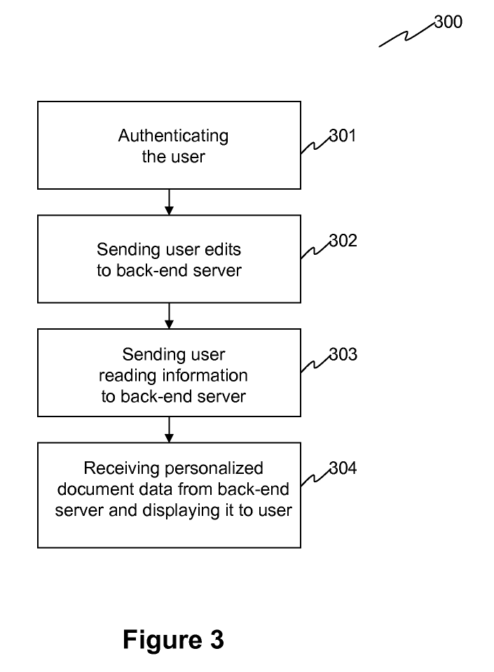

FIG. 3 illustrates an exemplary embodiment of an operating sequence 300 of a front-end portion of the inventive computerized personalized change-tracking system for collaboratively authored documents. At step 301, the front-end portion performs authentication of the user, verifying user access right and credentials. At step 302, the front-end portion detects user's edits of the document and sends the detected edits back to the back-end portion. The user's edits are sent together with information identifying the user (user-ID). At step 303, the front-end portion sends information on the pages or other portions of the document, which have been read by the user to the back-end portion, together with information identifying the user. At step 304, the front end portion accepts user-ID tagged document data from the back-end portion and displays it in a manner that makes personalized tracked changes obvious using the display portions 104 or 106.

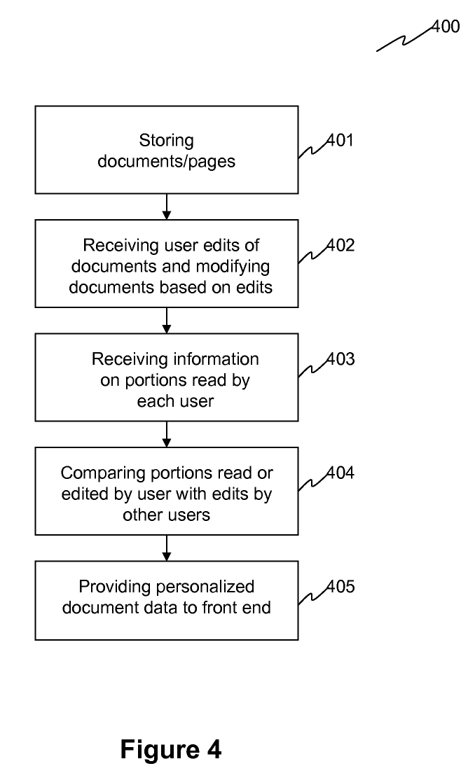

FIG. 4 illustrates an exemplary embodiment of an operating sequence of a back-end portion of the inventive computerized personalized change-tracking system for collaboratively authored documents. At step 401, the back-end portion 101 stores documents and pages in the storage portion 102. At step 402, the back-end portion 101 accepts user-ID tagged edits to a document and modifies the hosted document based on those edits. At step 403, the back-end portion 101 accepts user-ID tagged information about portions of a document that have been read or otherwise accessed by a user and stores this information. At step 404, the back-end portion 101 performs comparison of the portions of the document read, edited or otherwise accessed by the user. In other words, the back-end portion 101 performs a personalized “diff” operation, or change track on a document, where what one person has read or edited is compared against the current state of the document, as edited by everyone else in the collaboration team. Anything that one person has read or edited is marked differently from everything else that person has not read or edited. At step 405, the document, along with the personalized “diff” information, is provided back to the front-end, for display.

The aforesaid personalized “diff” operation involves flagging as “read” document portions that the user has in some way contacted, and the refreshing of document portions that co-authors subsequently change or edit. In one embodiment of the invention, when a user “contacts” a document, i.e. “treads down the snow” by reading or editing, the front-end module responsible for capturing this information and reporting it to the back-end should not report the entire document as “tread”. Rather, the front-end should pay close attention to what parts of the document the user is actually contacting. In the case of editing, that is simple. In the case of reading, however, a specialized display window can be implemented that keeps track of what text is actually being displayed, and for how long it is being displayed. For HTML documents used in the aforesaid Wiki system, this can be implemented in javascript: the code can at any time keep track of the scrollbar position, links that are clicked, and text fragments that are selected, all indicative that the user has read the corresponding fragments. This code can easily distinguish when the user just scrolls through a document quickly, versus when he or she spends time on specific portions or scroll slowly. The system is of course not perfect; we do not know if someone is reading the text, or if someone has simply opened a window and then gone to lunch for an hour. But it is still better than marking the entire document or page as read, the moment it is opened.

Once an embodiment of the inventive system captured this “contact” information, it proceeds to display it. In one embodiment of the inventive display system, all the text on a page starts out black. The more that a user contacts this text, the grayer it becomes. If a user edits/writes text, then it becomes grey immediately; as it is obvious that the user has read what he or she just wrote. But if a user is reading the text, the information captured about how long the text is displayed to the user is used by an embodiment of the inventive system to determine a gradient of black to grey used in displaying the text. According to an embodiment of the inventive technique, the more a user has read that text, the grayer (to a point) it becomes. However, if another user edits or adds text to the page, that edited portion becomes black again, i.e. it refreshes.

Another embodiment of the invention involves interface for displaying “personally contacted” versus “new to me” information is in the form of a navigation bar. In some portion of the document, or in a side bar, or integrated into the scroll bar itself, an embodiment of the inventive system displays a semi-transparent thumbnail of the document as a whole. This thumbnail does not show text; rather, it shows splotches of color. In one embodiment of the invention, the color is distributed as a heat map. Areas that the user has previously contacted are displayed as “hot”. Areas that are completely new to the user (whether because he or she has never read them before, or because another user has changed them) are “cold”. Areas of moderate activity lie somewhere in between.

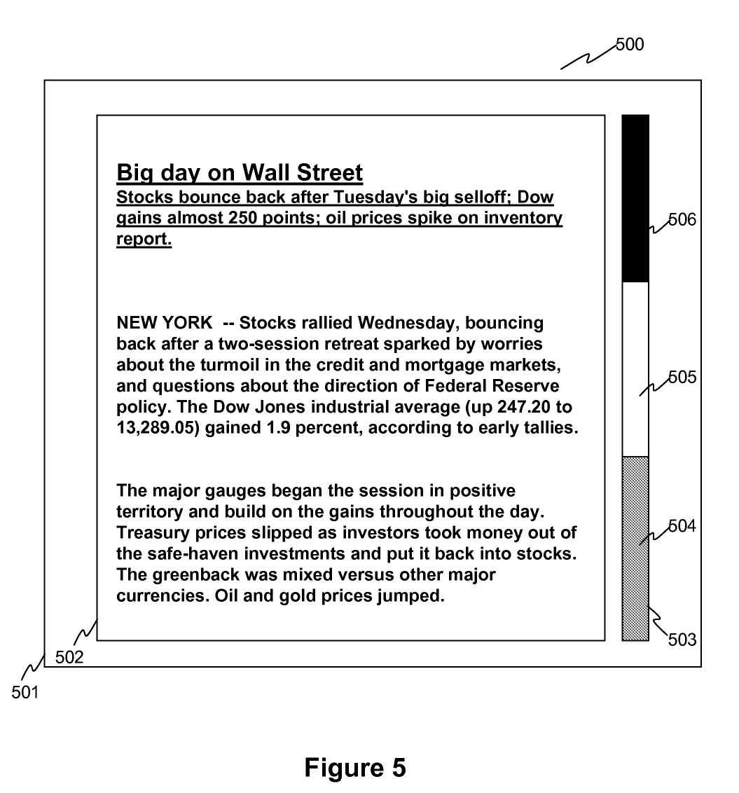

FIG. 5 illustrates an exemplary embodiment of a user interface portion 500 of the inventive computerized personalized change-tracking system for collaboratively authored documents. The shown embodiment of the user interface includes a display window portion 501. Within the display window portion 501, there is a text portion 502 containing the text of the document displayed to the user. Adjacent to and to the right of the aforesaid text portion is a scroll-bar 503, which includes colored segments 504, 505 and 506. The color of the colored segments 504, 505 and 506 represents the degree of user's familiarity with the text to the left of the aforesaid colored segments 504, 505 and 506. for example, the dark color of the portion 506 indicates that the corresponding text has been edited or written by the user and, therefore, the user is well familiar with that text. The light color of the portion 505 indicates that the corresponding text has not been read by the user and that the user is not familiar with the corresponding text. The gray color of the portion 504 indicates that the user has read the text and, therefore, is somewhat familiar with the corresponding text.

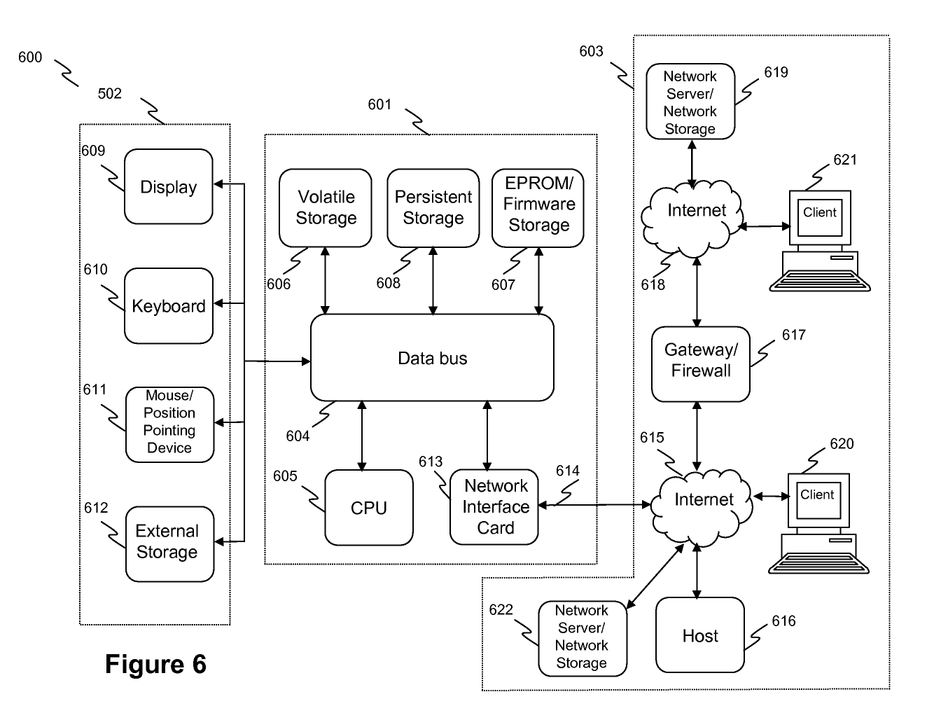

FIG. 6 is a block diagram that illustrates an embodiment of a computer/server system 600 upon which an embodiment of the inventive methodology may be implemented. The system 600 includes a computer/server platform 601, peripheral devices 602 and network resources 603.

The computer platform 601 may include a data bus 604 or other communication mechanism for communicating information across and among various parts of the computer platform 601, and a processor 605 coupled with bus 601 for processing information and performing other computational and control tasks. Computer platform 601 also includes a volatile storage 606, such as a random access memory (RAM) or other dynamic storage device, coupled to bus 604 for storing various information as well as instructions to be executed by processor 605. The volatile storage 606 also may be used for storing temporary variables or other intermediate information during execution of instructions by processor 605. Computer platform 601 may further include a read only memory (ROM or EPROM) 607 or other static storage device coupled to bus 604 for storing static information and instructions for processor 605, such as basic input-output system (BIOS), as well as various system configuration parameters. A persistent storage device 608, such as a magnetic disk, optical disk, or solid-state flash memory device is provided and coupled to bus 601 for storing information and instructions.

Computer platform 601 may be coupled via bus 604 to a display 609, such as a cathode ray tube (CRT), plasma display, or a liquid crystal display (LCD), for displaying information to a system administrator or user of the computer platform 601. An input device 610, including alphanumeric and other keys, is coupled to bus 601 for communicating information and command selections to processor 605. Another type of user input device is cursor control device 611, such as a mouse, a trackball, or cursor direction keys for communicating direction information and command selections to processor 604 and for controlling cursor movement on display 609. This input device typically has two degrees of freedom in two axes, a first axis (e.g., x) and a second axis (e.g., y), that allows the device to specify positions in a plane.

An external storage device 612 may be connected to the computer platform 601 via bus 604 to provide an extra or removable storage capacity for the computer platform 601. In an embodiment of the computer system 600, the external removable storage device 612 may be used to facilitate exchange of data with other computer systems.

The invention is related to the use of computer system 600 for implementing the techniques described herein. In an embodiment, the inventive system may reside on a machine such as computer platform 601. According to one embodiment of the invention, the techniques described herein are performed by computer system 600 in response to processor 605 executing one or more sequences of one or more instructions contained in the volatile memory 606. Such instructions may be read into volatile memory 606 from another computer-readable medium, such as persistent storage device 608. Execution of the sequences of instructions contained in the volatile memory 606 causes processor 605 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 605 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 608. Volatile media includes dynamic memory, such as volatile storage 606. Transmission media includes coaxial cables, copper wire and fiber optics, including the wires that comprise data bus 604. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 605 for execution. For example, the instructions may initially be carried on a magnetic disk from a remote computer. Alternatively, a remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on the data bus 604. The bus 604 carries the data to the volatile storage 606, from which processor 605 retrieves and executes the instructions. The instructions received by the volatile memory 606 may optionally be stored on persistent storage device 608 either before or after execution by processor 605. The instructions may also be downloaded into the computer platform 601 via Internet using a variety of network data communication protocols well known in the art.

The computer platform 601 also includes a communication interface, such as network interface card 613 coupled to the data bus 604. Communication interface 613 provides a two-way data communication coupling to a network link 614 that is connected to a local network 615. For example, communication interface 613 may be an integrated services digital network (ISDN) card or a modem to provide a data communication connection to a corresponding type of telephone line. As another example, communication interface 613 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 613 sends and receives electrical, electromagnetic or optical signals that carry digital data streams representing various types of information.

Network link 613 typically provides data communication through one or more networks to other network resources. For example, network link 614 may provide a connection through local network 615 to a host computer 616, or a network storage/server 617. Additionally or alternatively, the network link 613 may connect through gateway/firewall 617 to the wide-area or global network 618, such as an Internet. Thus, the computer platform 601 can access network resources located anywhere on the Internet 618, such as a remote network storage/server 619. On the other hand, the computer platform 601 may also be accessed by clients located anywhere on the local area network 615 and/or the Internet 618. The network clients 620 and 621 may themselves be implemented based on the computer platform similar to the platform 601.

Local network 615 and the Internet 618 both use electrical, electromagnetic or optical signals that carry digital data streams. The signals through the various networks and the signals on network link 614 and through communication interface 613, which carry the digital data to and from computer platform 601, are exemplary forms of carrier waves transporting the information.

Computer platform 601 can send messages and receive data, including program code, through the variety of network(s) including Internet 618 and LAN 615, network link 614 and communication interface 613. In the Internet example, when the system 601 acts as a network server, it might transmit a requested code or data for an application program running on client(s) 620 and/or 621 through Internet 618, gateway/firewall 617, local area network 615 and communication interface 613. Similarly, it may receive code from other network resources.

The received code may be executed by processor 605 as it is received, and/or stored in persistent or volatile storage devices 608 and 606, respectively, or other non-volatile storage for later execution. In this manner, computer system 601 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized personalized change-tracking system for collaboratively authored documents. It is intended that the specification and examples be considered as exemplary only, with a true scope and spirit of the invention being indicated by the following claims.

What is claimed is:

1. A method comprising:
a. Marking a document as unaccessed;
b. Providing the document to a user;
c. Detecting a portion of the document accessed by the user;
d. Marking the accessed portion of the document as read;
e. Determining whether the read portion of the document has been modified by another user; and
f. If the read portion of the document has been modified by another user, reverting the read portion of the document to unaccessed.

2. The method of claim 1, wherein marking the document as unaccessed comprises rendering the document in a dark font color.

3. The method of claim 1, wherein marking the accessed portion of the document as read comprises rendering the accessed portion of the document in a light font color.

4. The method of claim 1, wherein marking the accessed portion of the document as read comprises rendering the accessed portion of the document in a color, the color being dependent on a length of time that the user has spent accessing the portion of the document.

5. The method of claim 1, wherein providing the document to the user further comprises providing a graphical object indicating the accessed portions of the document.

6. The method of claim 5, wherein the graphical object comprises a side bar disposed adjacent to the document and having at least one color region indicative of a length of time that the user has spent accessing the corresponding portion of the document.

7. The method of claim 1, wherein detecting the portion of the document accessed by the user comprises detecting editing of the document by the user.

8. The method of claim 1, wherein detecting the portion of the document accessed by the user comprises detecting reading of the document by the user.

9. The method of claim 1, wherein detecting the portion of the document accessed by the user comprises measuring a length of time that the user spends reading of the document.

10. The method of claim 1, wherein the portion of the document comprises document body, document metadata or at least one document attribute.

11. A computer readable medium embodying a set of computer-executable instructions implementing a method comprising:
a. Marking a document as unaccessed;
b. Providing the document to a user;
c. Detecting a portion of the document accessed by the user;
d. Marking the accessed portion of the document as read;
e. Determining whether the read portion of the document has been modified by another user; and
f. If the read portion of the document has been modified by another user, reverting the read portion of the document to unaccessed.

12. A computer readable medium of claim 11, wherein marking the document as unaccessed comprises rendering the document in a dark font color.

13. The computer readable medium of claim 11, wherein marking the accessed portion of the document as read comprises rendering the accessed portion of the document in a light font color.

14. The computer readable medium of claim 11, wherein marking the accessed portion of the document as read comprises rendering the accessed portion of the document in a color, the color being dependent on a length of time that the user has spent accessing the portion of the document.

15. The computer readable medium of claim 11, wherein providing the document to the user further comprises providing a graphical object indicating the accessed portions of the document.

16. The computer readable medium of claim 15, wherein the graphical object comprises a side bar disposed adjacent to the document and having at least one color region indicative of a length of time that the user has spent accessing the corresponding portion of the document.

17. The computer readable medium of claim 11, wherein detecting the portion of the document accessed by the user comprises detecting editing of the document by the user.

18. The computer readable medium of claim 11, wherein detecting the portion of the document accessed by the user comprises detecting reading of the document by the user.

19. The computer readable medium of claim 11, wherein detecting the portion of the document accessed by the user comprises measuring a length of time that the user spends reading of the document.

20. The computer readable medium of claim 11, wherein the portion of the document comprises document body, document metadata or at least one document attribute.

21. A change tracking system comprising a front end portion operable to:
i. authenticate a user to determine an identity of the user;
ii. detect changes to a document made by the user;
iii. send the detected changes to a back end portion together with information on the identity of the user;
iv. collect information on a portion of the document accessed by the user;
v. send information on a portion of the document accessed by the user to the back end portion together with the information on the identity of the user;
vi. receive a personalized document data from the back-end portion; and
vii. display the received data to the user.

22. The change tracking system of claim 21, wherein the portion of the document comprises document body, document metadata or at least one document attribute.

23. A change tracking system comprising:
a. A front end portion operable to:
i. Provide a document to a user; and
ii. Detect a portion of the document accessed by the user; and
b. A back end portion operable to:
i. Store the document;
ii. Initially mark the document as unaccessed;
iii. Mark the accessed portion of the document as read;
iv. Determine whether the read portion of the document has been modified by another user; and
v. If the read portion of the document has been modified by another user, revert the read portion of the document to unaccessed.

24. The system of claim 23, wherein the front end portion comprises a display operable to render document marked as unaccessed in a dark font color.

25. The system of claim 23, wherein the front end portion comprises a display operable to render the accessed portion of the document marked as read in a light font color.

26. The system of claim 23, wherein the front end portion comprises a display operable to render the accessed portion of the document in a color, the color being dependent on a length of time that the user has spent accessing the portion of the document.

27. The system of claim 23, wherein the front end portion comprises a display comprising a graphical object indicating the accessed portions of the document.

28. The system of claim 27, wherein the graphical object comprises a side bar disposed adjacent to the document and having at least one color region indicative of a length of time that the user has spent accessing the corresponding portion of the document.

29. The system of claim 27, wherein the portion of the document comprises document body, document metadata or at least one document attribute.
